(19) United States
(12) Patent Application Publication
(10) Pub. No.: US 2016/0117955 A1
(43) Pub. Date: Apr. 28, 2016

(54) ARTICLE FOR TEACHING CHILD TO RIDE BICYCLE

(71) Applicant: Donald Oroian, San Antonio, TX (US)

(72) Inventor: Donald Oroian, San Antonio, TX (US)

(21) Appl. No.: 14/526,100

(22) Filed: Oct. 28, 2014

(51) Int. Cl. G09B 19/16

(52) U.S. Cl. CPC G09B 19/167

(57) ABSTRACT

An article for use in teaching a child to ride a bicycle includes a substantially rigid backboard and a harness affixed to the backboard and configured for securing the article to the child. A handhold is affixed to the front face of the backboard and a cushion is affixed to the back face. The harness is arranged to secure the article to the child such that the cushion is pressed firmly between the backboard and a generally central region of the child's upper back while the handhold is outwardly presented for grasping by an instructor. The handhold includes a strap, which is affixed to the backboard through a first anchor assembly having a D-ring, and a second anchor assembly having a D-ring, through which the loose end of the handhold strap loops. The harness includes chest, abdominal and shoulder straps as well as fasteners and size adjusters.

### FIELD OF THE INVENTION

The present invention relates to child development. More particularly, the invention relates to an article for use in teaching a child to ride a bicycle.

### BACKGROUND OF THE INVENTION

Learning to ride a bicycle is a rite of passage for children worldwide. In conquering this feat, the age old progression involves riding with training wheels until the child develops the courage to cast the training wheels aside and go it alone. Unfortunately, the abrupt transition does not always go well and at least some children suffer serious injury while many children suffer injury at least to their pride and self confidence.

Recognizing this shortcoming of the early prior art, at least some devices have been implemented through which a caregiver may provide “hands-on” assistance to the young rider in training transitioning to “two-wheels.” In particular, such prior art devices are generally characterized as attachments to the bicycle to provide a handhold for an instructor. Unfortunately, however, the outcome with such devices is often not much better than before. To be sure, handholds attached to the seat or frame elements of the bicycle suffer a number of deficiencies. For example, their use prevents the instructor from being at the ready to catch the child in the event of an upset and, at the same time, do not give the child any tactile reassurance that the instructor is “there.” In the end, accidents still happen and some children never attain, or at least are delayed in attaining, the confidence required to ride alone.

With the shortcomings of the prior art clearly in mind, it is therefore an overriding object of the present invention to improve over the prior art by providing an article for use in teaching a child to ride a bicycle that provides the child with a tactile indication of the presence of the instructor while also leaving the child substantially unencumbered while riding. Additionally, it is an object of the present invention to provide such an article for use in teaching a child to ride a bicycle that also virtually ensures that a child is caught by the instructor in the event of an upset. Still further, it is an object of the present invention to provide such an article for use in teaching a child to ride a bicycle that is lightweight and comfortable in use. Finally, it is an object of the present invention to provide such an article for use in teaching a child to ride a bicycle that is readily and economically manufactured, thereby making the article for use in teaching a child to ride a bicycle available to the widest range of children regardless of financial means.

### SUMMARY OF THE INVENTION

In accordance with the foregoing objects, the present invention—an article for use in teaching a child to ride a bicycle—generally comprises a substantially rigid backboard and a harness affixed to the substantially rigid backboard and adapted to secure the article to the child. In critical aspects of the present invention, the article also comprises a handhold affixed to the front face of the substantially rigid backboard and a cushion affixed to the back face of the substantially rigid backboard. To this end, the harness is further adapted to secure the article to the child such that the cushion is pressed firmly between the substantially rigid backboard and a generally central region of the child's upper back while the handhold is outwardly presented for grasping by an instructor.

In at least the most preferred implementations of the present invention, the handhold comprises a strap, which in such implementations is affixed to the front face of the substantially rigid backboard through an interposed anchor assembly. The interposed anchor assembly preferably comprises a D-ring, through which the handhold strap is affixed to the front face of the substantially rigid backboard. Additionally, in the most preferred implementations of the present invention, the handhold further comprises a second anchor assembly, which second anchor assembly also comprises a D-ring through which the loose end of the handhold strap is adapted to loop.

In at least some implementations of the present invention, the handhold strap comprises a first field of loop type material and a second field of hook type material, the first and second fields being cooperatively adapted to substantially secure the strap in place between the first D-ring and the second D-ring of the respective anchor assemblies.

In at least the most preferred implementations of the present invention, the harness comprises a plurality of straps, which include at minimum a plurality of chest straps but also preferably include a plurality of abdominal straps as well as a plurality of shoulder straps. In any case, the plurality of harness straps also preferably include fasteners such as, for example, side release buckle or adjustable side release buckles, double D-ring buckles or the like. As required depending on the employed fasteners, the plurality of harness straps should further include length adjusters for accommodating the widest size range of children. Such length adjustments may comprise, for example, tri bar adjuster buckles or the like.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a partially cut away perspective view, the most preferred implementation of the article for teaching a child to ride a bicycle of the present invention;

FIG. 2 shows, in a perspective view generally corresponding to the view of FIG. 1, the backboard of the article for teaching a child to ride a bicycle of FIG. 1;

FIG. 3 shows, in a top plan view, various features of the backboard of FIG. 2;

FIG. 4 shows, in a detail view located in FIG. 3, various details of the backboard of FIG. 2;

FIG. 5 shows, in a cross-sectional view taken through cut line 5-5 of FIG. 4, various additional details of the backboard of FIG. 2;

FIG. 6 shows, in a perspective view generally corresponding to the views of FIGS. 1 and 2, the backboard of FIG. 2 as fitted with various harness straps in preparation for assembly of the backboard of FIG. 2 into the article for teaching a child to ride a bicycle of FIG. 1;

FIG. 7 shows, in a perspective view, the preferred implementation of an anchor assembly as utilized in the preferred implementation of the article for teaching a child to ride a bicycle of FIG. 1;

FIG. 8 shows, in a top plan view, the anchor assembly of FIG. 7;

FIG. 9 shows, in a side elevational view, the anchor assembly of FIG. 7;

FIG. 10 shows, in a cross-sectional view taken through cut line 10-10 of FIG. 8, various details of the interface of the D-ring and anchor of the anchor assembly of FIG. 7;

FIG. 11 shows, in a partially cut away perspective view generally corresponding to the view of FIG. 7, a second anchor assembly, fitted with a hand strap, as utilized in the preferred implementation of the article for teaching a child to ride a bicycle of FIG. 1;

FIG. 12 shows, in a partially cut away and exploded perspective view generally corresponding to the views of FIGS. 1, 2 and 6, various details of the integration of the anchor assemblies of FIGS. 7 and 11 with the backboard of FIG. 2 in further preparation for assembly of the backboard of FIG. 2 into the article for teaching a child to ride a bicycle of FIG. 1;

FIG. 13 shows, in a partially cut away perspective view generally corresponding to the view of FIG. 12, the backboard of FIG. 2 with the anchor assemblies of FIGS. 7 and 11 integrated therewith;

FIG. 14 shows, in a perspective view generally corresponding to the views of FIGS. 1, 2, 6, 12 and 13, the preferred implementation of a frame as utilized to affix the cushion in the preferred implementation of the article for teaching a child to ride a bicycle of FIG. 1;

FIG. 15 shows, in a top plan view, various features of the frame of FIG. 14;

FIG. 16 shows, in a in a detail view located in FIG. 15, various details of the frame of FIG. 14;

FIG. 17 shows, in a cross-sectional view taken through cut line 17-17 of FIG. 16, various additional details of the frame of FIG. 14;

FIG. 18 shows, in an exploded perspective view generally corresponding to the views of FIGS. 1, 2, 6, 12, 13 and 14, various details of the integration of the frame of FIG. 14 about a durable cover forming a part of the cushion of the preferred implementation of the article for teaching a child to ride a bicycle of FIG. 1;

FIG. 19 shows, in a perspective view generally corresponding to the view of FIG. 18, the frame and durable cover as integrated together in preparation for further assembly of the article for teaching a child to ride a bicycle of FIG. 1;

FIG. 20 shows, in a partially cut away perspective view generally corresponding to the view of FIG. 1, various details of the final assembly prior to use of the article for teaching a child to ride a bicycle of FIG. 1;

FIGS. 21 and 22 show, in top plan views, various details of the utilization of hand strap of FIG. 11 in connection with the anchor assemblies of FIGS. 7 and 11; and

FIG. 23 shows, in a perspective view, various details of the deployment in use of the article for teaching a child to ride a bicycle of FIG. 1.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

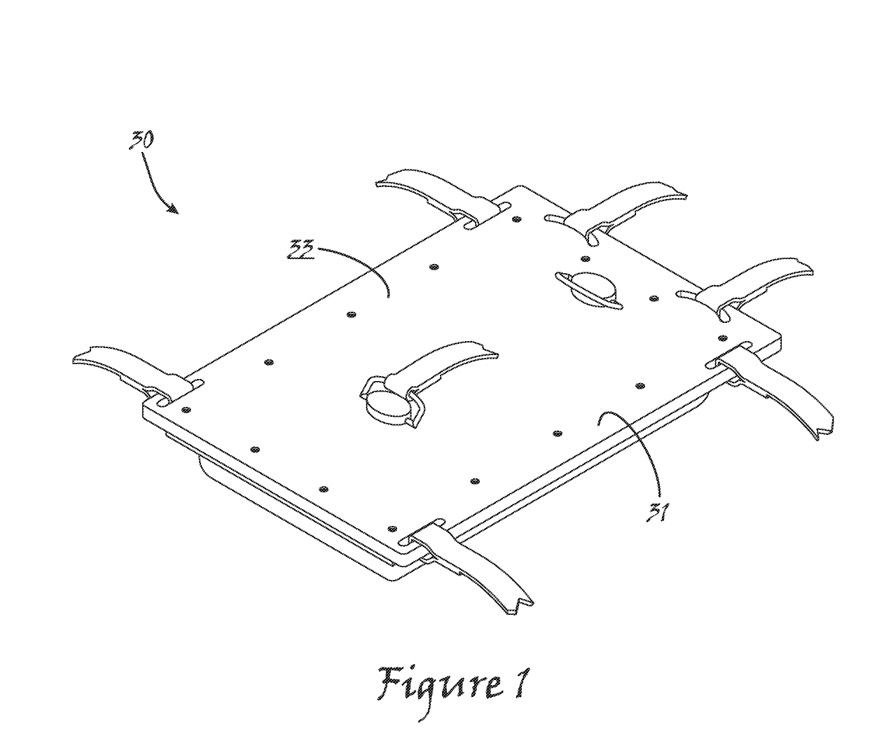

Referring now to the figures, and to FIGS. 1, 21, 22 and 23 in particular, the article 30 of the present invention for use in teaching a child 62 to ride a bicycle is shown to generally comprise a substantially rigid backboard 31 and a harness affixed to the substantially rigid backboard 31 and adapted to secure the article 30 to the child 62. In critical aspects of the present invention, the article 31 also comprises a handhold affixed to the front face 33 of the substantially rigid backboard 31 and a cushion affixed to the back face 35 of the substantially rigid backboard 31. To this end, the harness is further adapted to secure the article 30 to the child 62 such that the cushion is pressed firmly between the substantially rigid backboard 31 and a generally central region of the child's upper back while the handhold is outwardly presented for grasping in the hand 64 of an instructor 63.

In at least the most preferred implementations of the present invention, the handhold comprises a strap 50, which in such implementations is affixed to the front face 33 of the substantially rigid backboard 31 through an interposed anchor assembly. The interposed anchor assembly preferably comprises a D-ring 49, through which the handhold strap 50 is affixed to the front face 33 of the substantially rigid backboard 31. Additionally, in the most preferred implementations of the present invention, the handhold further comprises a second anchor assembly, which second anchor assembly also comprises a D-ring 49 through which the loose end of the handhold strap 50 is adapted to loop.

In at least some implementations of the present invention, the handhold strap 50 comprises a first field of loop type material 52 and a second field of hook type material 51, the first and second fields 52, 51 being cooperatively adapted to substantially secure the strap 50 in place between the first D-ring 49 and the second D-ring 49 of the respective anchor assemblies.

In at least the most preferred implementations of the present invention, the harness comprises a plurality of straps 38, 39, 40, which include at minimum a plurality of chest straps 38 but also preferably include a plurality of abdominal straps 39 as well as a plurality of shoulder straps 40. In any case, the plurality of harness straps also preferably include fasteners 41 such as, for example, side release buckle or adjustable side release buckles, double D-ring buckles or the like. As required depending on the employed fasteners 41, the plurality of harness straps 38, 39, 40 should further include length adjusters 42 for accommodating the widest size range of children. Such length adjusters 42 may comprise, for example, tri bar adjuster buckles or the like.

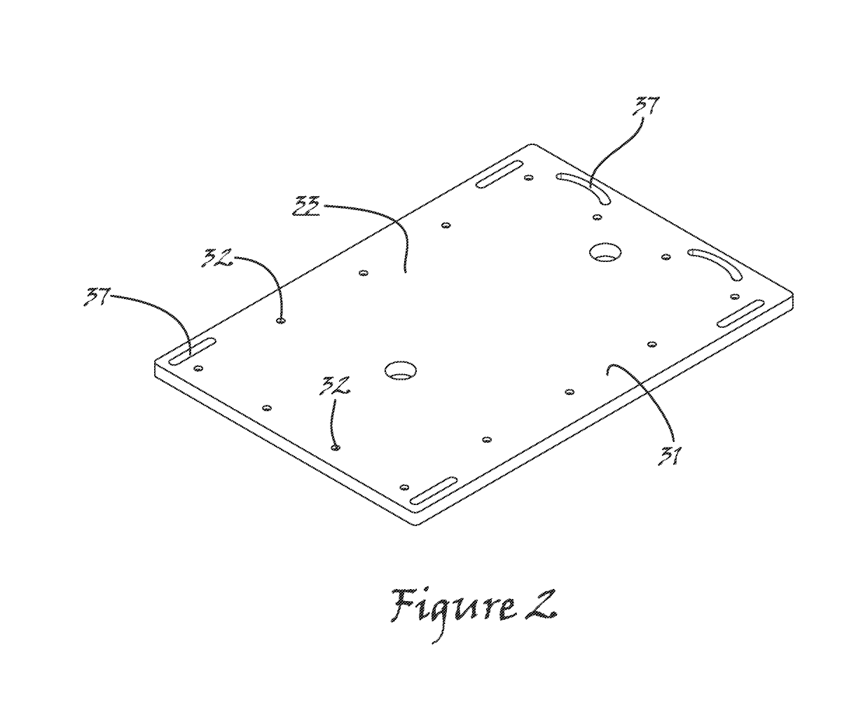

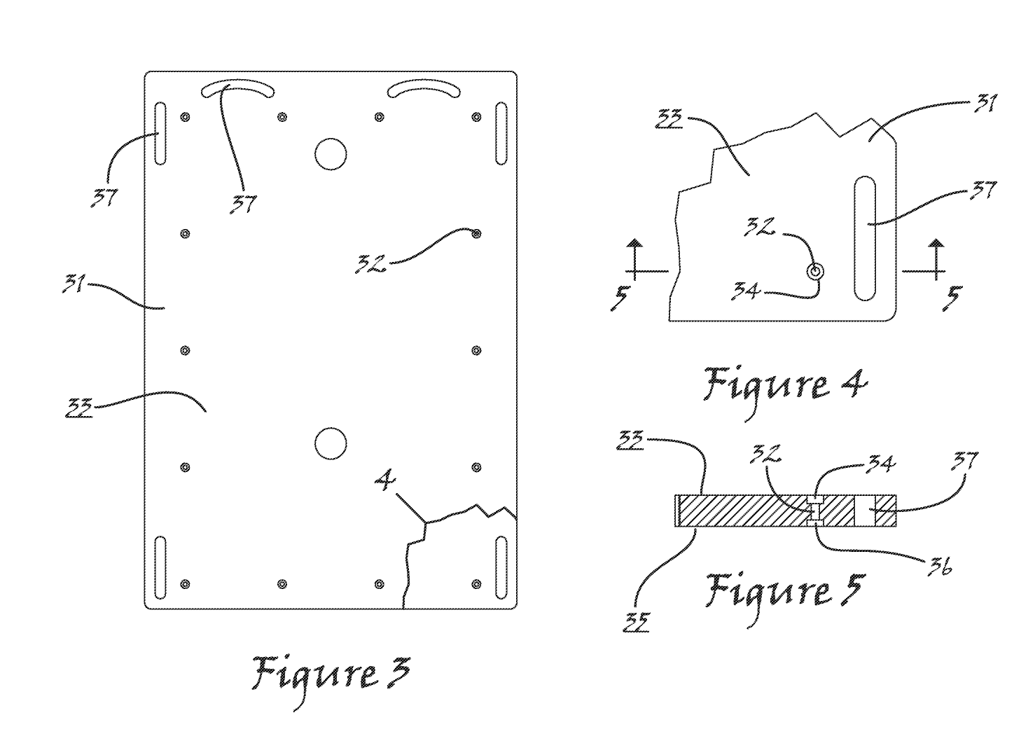

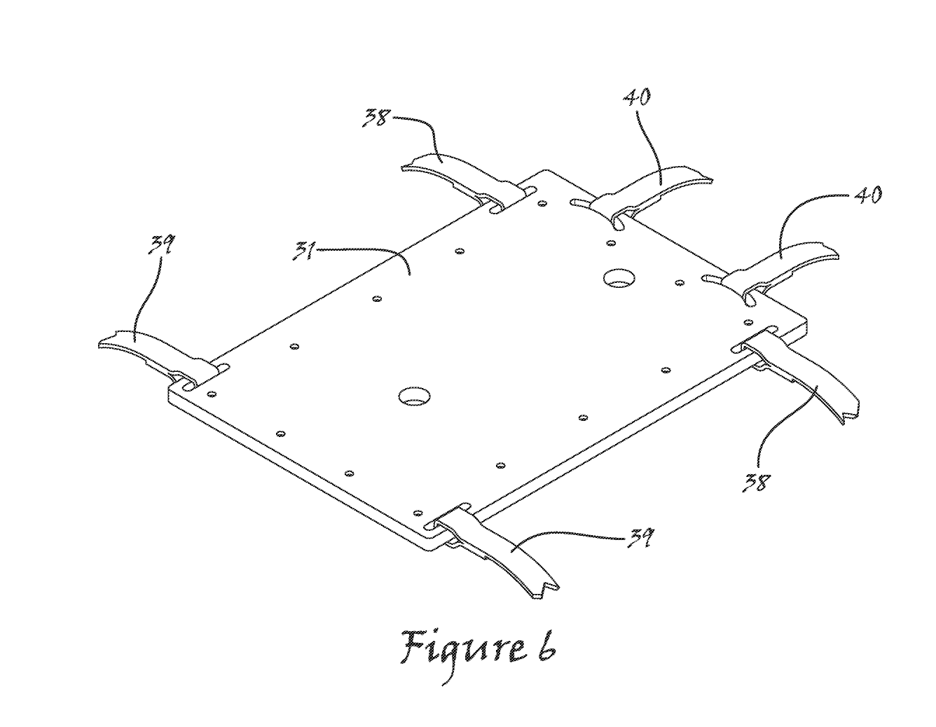

Referring now to FIGS. 2 through 5, in particular, the substantially rigid backboard 31, which most preferably comprises a lightweight but nonetheless sturdy material such as, for example, polycarbonate or aluminum, is shown to generally comprise substantially planar structure having provided in connection therewith a plurality of through holes 32 for mounting the cushion (as will be better understood further herein) and a plurality of harness slots 37 for affixing the various harness straps 38, 39, 40 (as also will be better understood further herein). As will be more clear upon discussion of mounting the cushion, the front face 33 of the substantially rigid backboard 31 is provided with a counterbore 34 coaxial with each through hole 32 and, similarly, the back face 35 of the substantially rigid backboard 31 is provided with a counterbore 36 coaxial with each through hole 32. In any case, as particular shown in FIG. 4, the chest straps 38, abdominal straps 39 and shoulder straps 40 are preferably sewn into or otherwise placed in and about the harness slots 37 as an initial step in the construction of the article 30 in order to ensure easy access with a sewing machine, radio frequency welding machine or like apparatus.

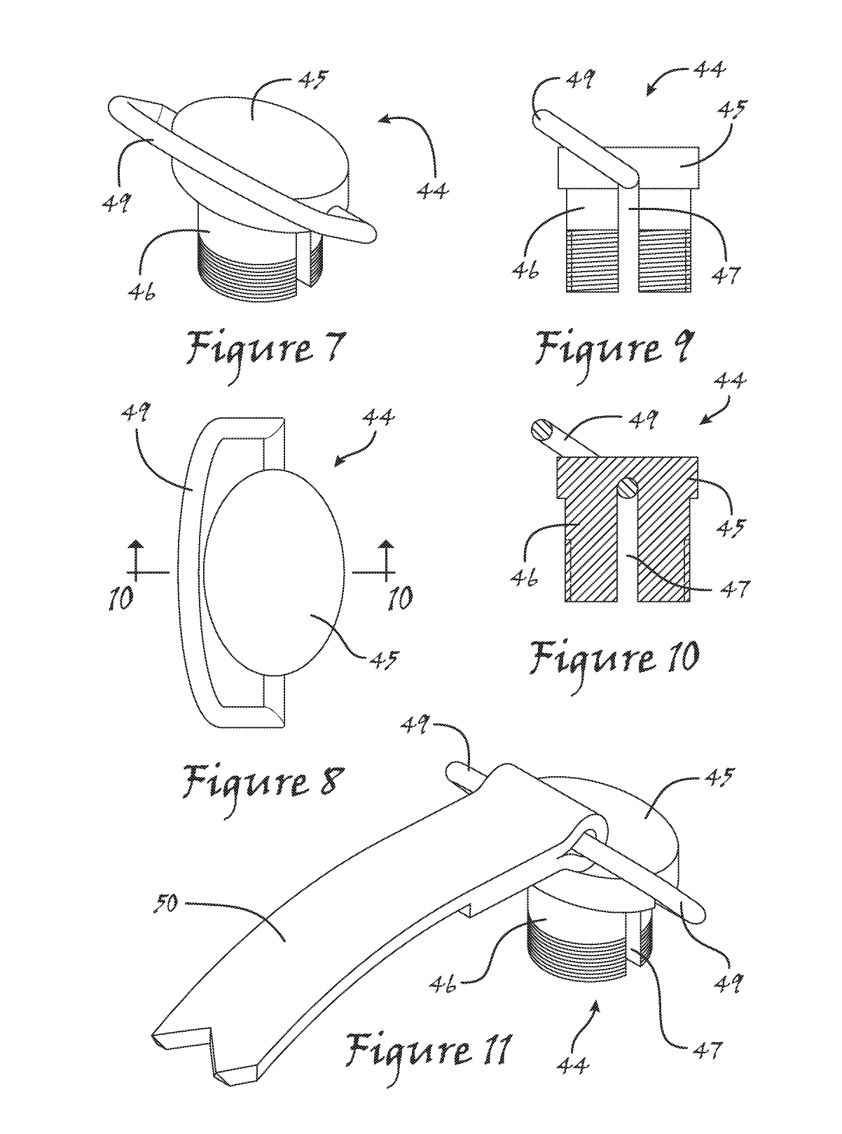

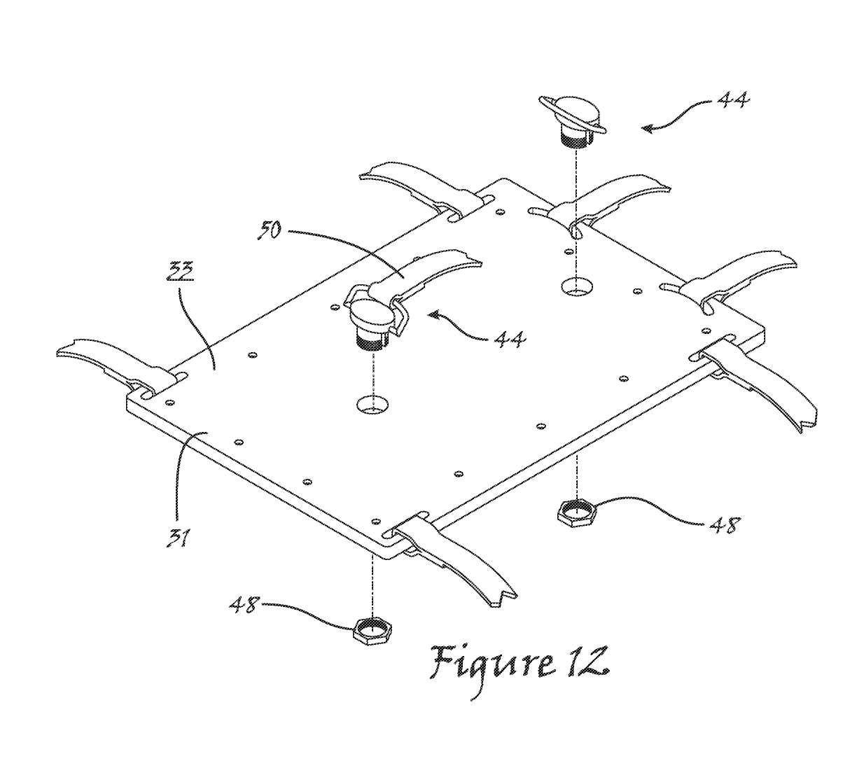

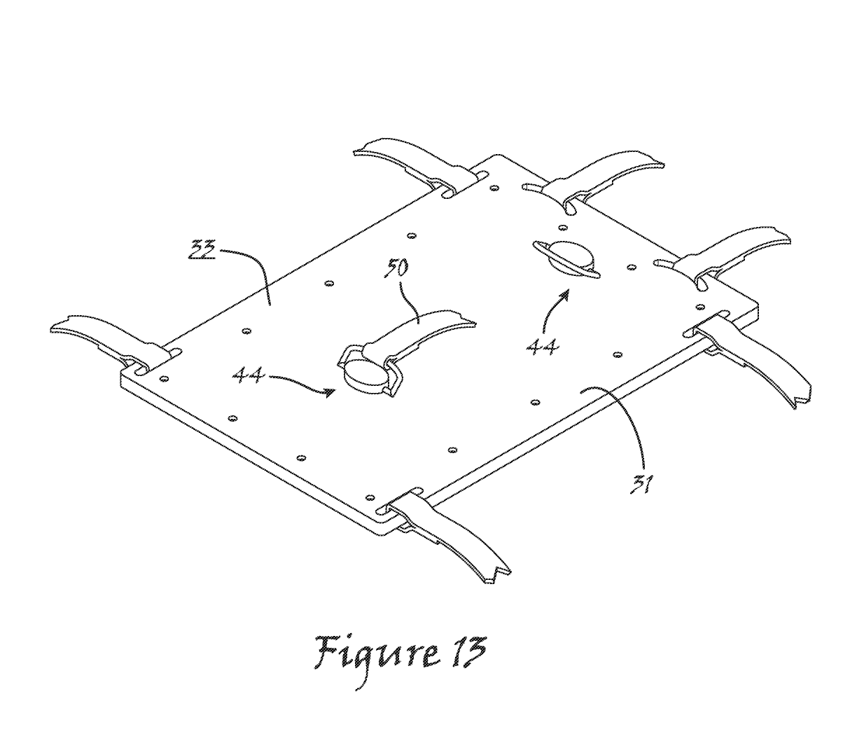

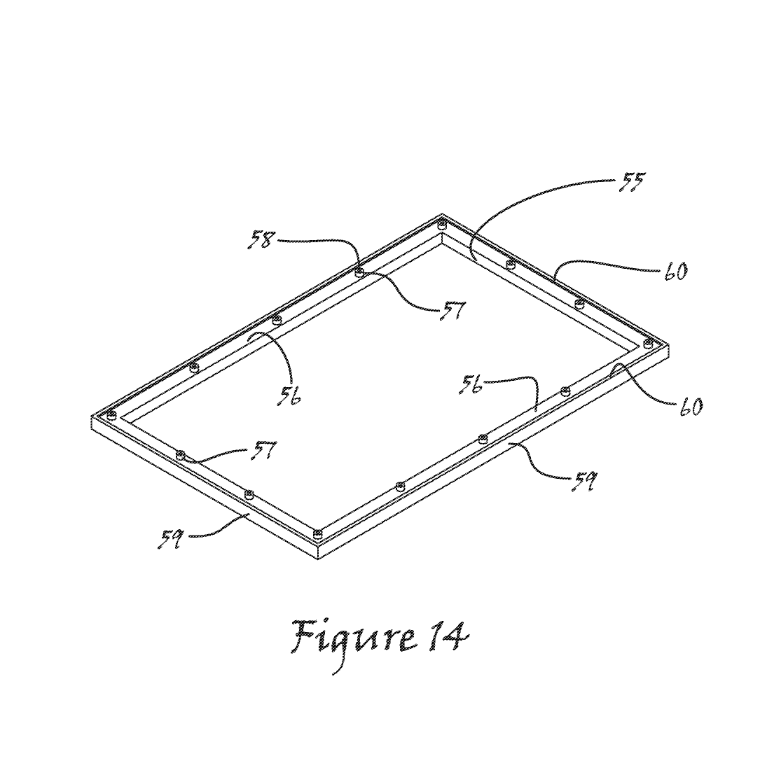

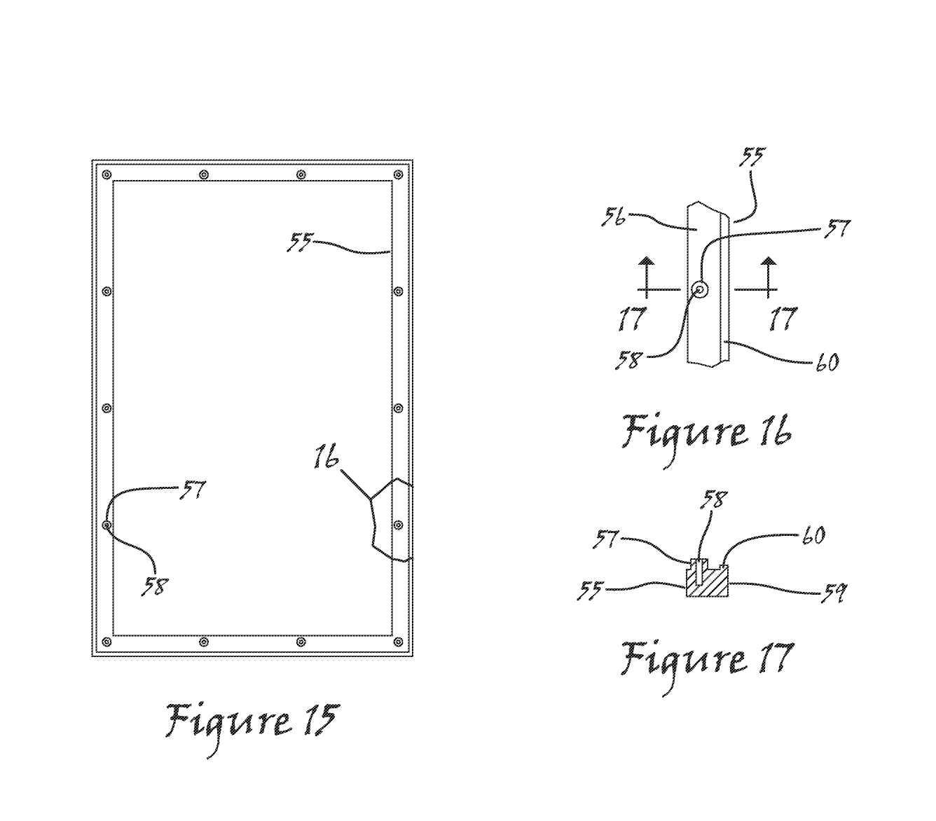

Referring now to FIGS. 7 through 11, in particular, the anchor assemblies are shown to each comprise anchor 44, which may be readily formed as a cap 45 having extending downward therefrom a threaded plug 46 with a transverse slot 47 formed therein. As clearly shown in the Figures, the transverse slot is sized and shaped to hold the respective D-ring 49 operably in position about each anchor 44. Although otherwise identical, it is noted, as depicted in FIG. 11, that in the preferred implementation of the present invention one anchor assembly is fitted with a hand strap 50. In any case, the anchor assemblies are, as particular shown in FIG. 12, secured to the substantially rigid backboard 31 with retaining rings 48 having internal threading sized to match the external threading of the plugs 46.

As previously noted, one critical aspect of the present invention comprises the provision of a tactile interface between the article 30 and the upper back of the child 62. To this end, a cushion is affixed to the back face 35 of the substantially rigid backboard 31. Although other specific implementations are readily possible, Applicant has found that such a cushion, which generally comprises a quantity of padding 53 enclosed within a durable cover 54, may be affixed to the back face 34 of the substantially rigid backboard 31 with a frame 55.

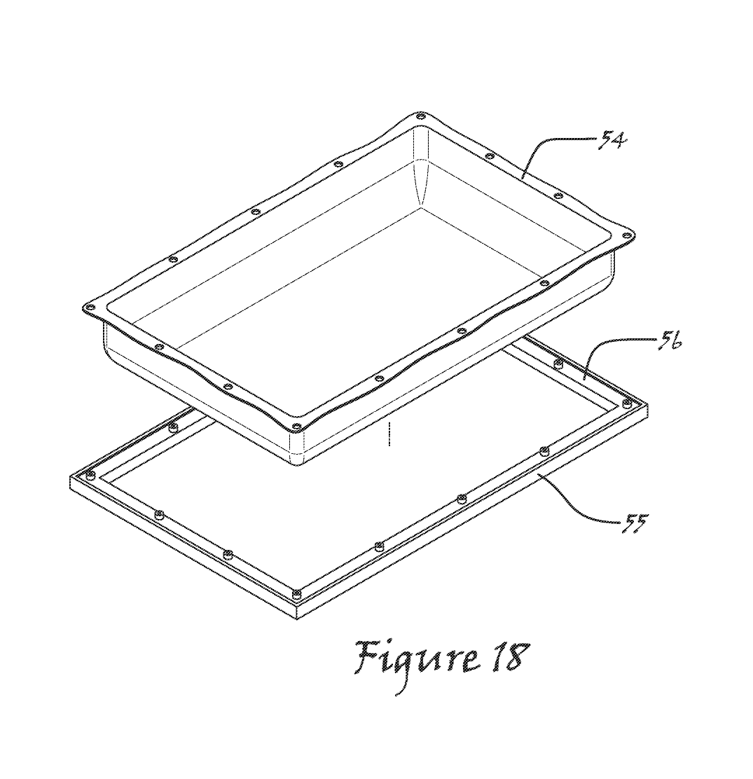

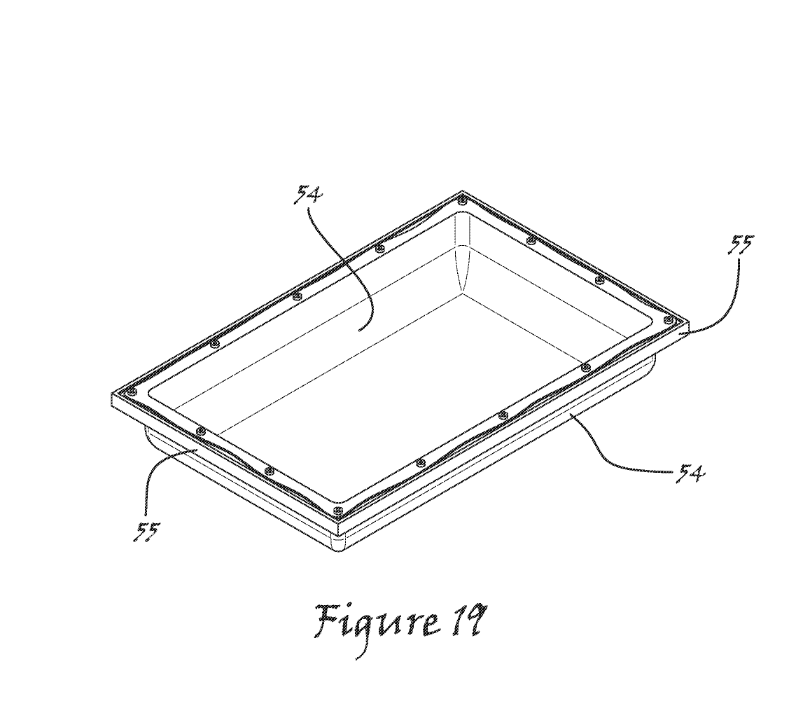

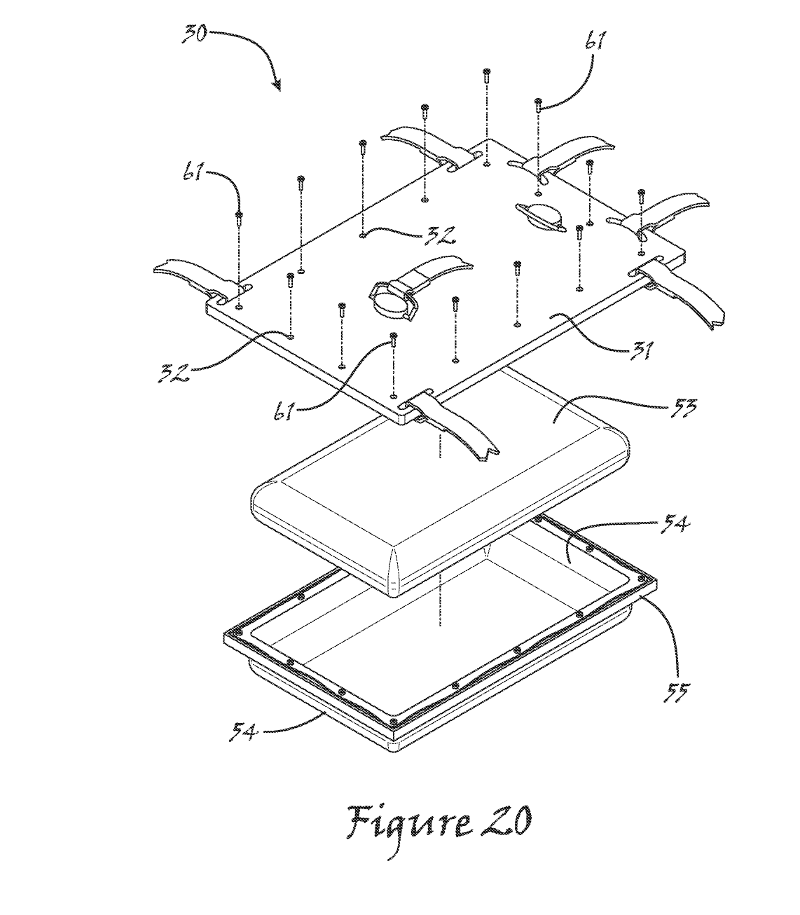

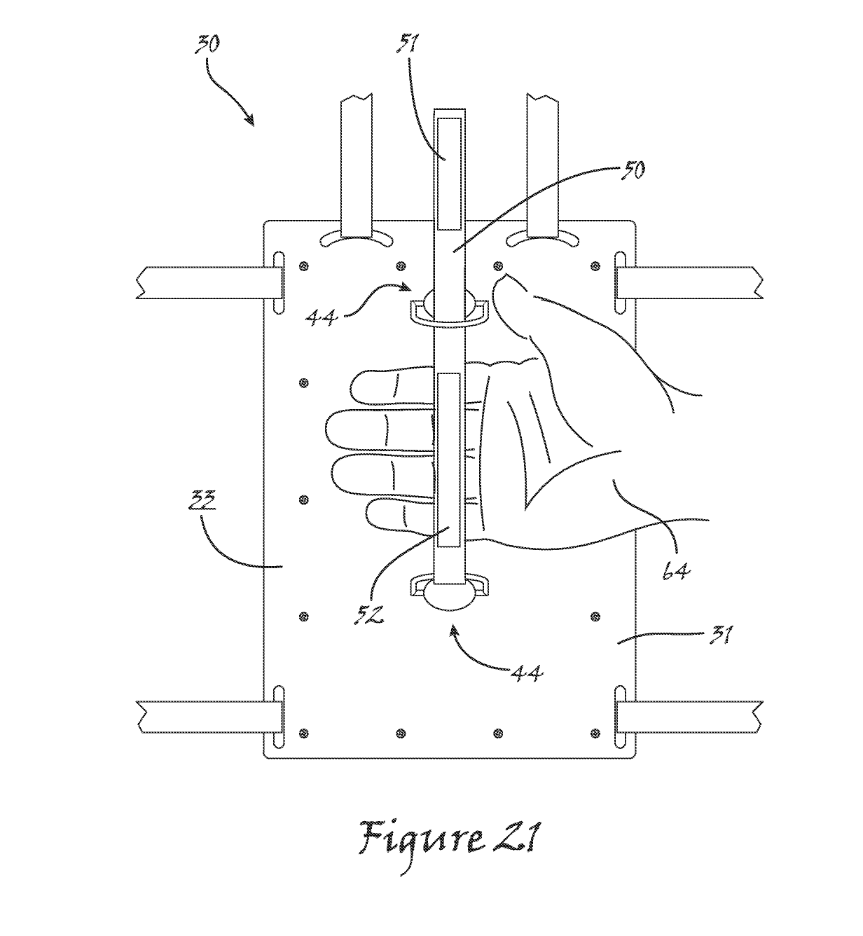

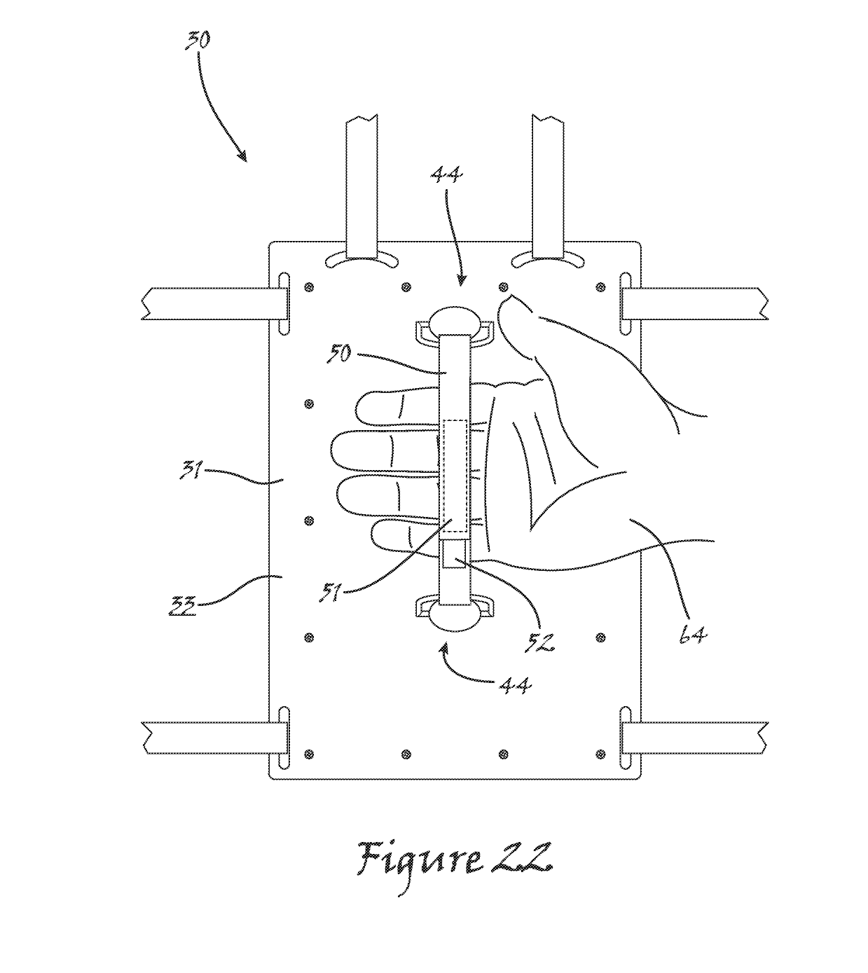

As particularly shown in FIGS. 14 through 17, the frame generally comprises a plurality of studs 57 arranged about a recess 56 defined by a rim 60 about the outer edges 59 of the frame 55. While the recess 56 allows for capture of the outer edges of the durable cover 54, the studs 57, each of which comprises a tapped hole 58 therein, serve to secure the durable cover 54 in place as shown in FIGS. 18 and 19. As shown in FIG. 20, with the durable cover 54 mounted to the frame 55 and the padding 53 placed within the durable cover 54, the frame 55 is placed in position on the back face 35 of the substantially rigid backboard 31. To this end, it is noted that the previously described counterbores 36 on the back face of the substantially rigid backboard 31 are sized, shaped, arranged and otherwise adapted to receive therein the studs 57 of the frame. In any case, with the frame 55 in place and holding the cushion adjacent the back face 35 of the substantially rigid backboard 31, the frame 55 is secured to the substantially rigid backboard 31 using conventional fasteners 61 such as, for example, pan head machine screws, self tapping screws or the like as shown in FIGS. 1, 20, 21 and 22.

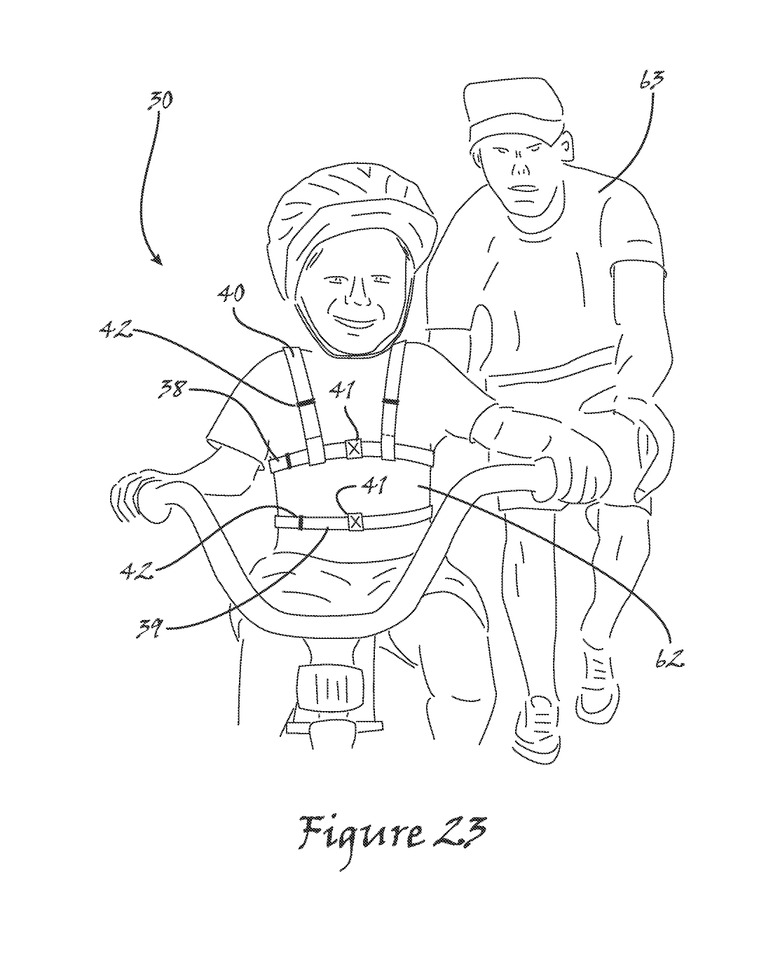

In use, the article 30 for use in teaching a child 62 to ride a bicycle is positioned in place as an article of wear as particularly shown in FIG. 23. As will be appreciated by those of ordinary skill in the art in light of this exemplary description, the various fasteners 41 and length adjusters 42 of the harness are utilized to ensure that the article 30 is securely affixed to the child 62. Once placed and secured, the instructor 63 secures a hand 64 about the hand strap 50 as shown in FIGS. 21 and 22 and, thereafter, provides guidance to the child 62 as shown in FIG. 23. As will also be appreciated by those of ordinary skill in the art in light of this exemplary description, the instructor 63 is able to provide tactile indication to the child 62 of the instructor's presence as well as to provide control input as necessary. Additionally, it is noted, the instructor 63 is, if necessary, able to utilize the article 30 to snatch the child 62 from the bicycle in the event of a sudden upset, thereby ensuring that the child 62 is not injured.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, those of ordinary skill in the art will recognize that although the article 30 of the present invention provides a much greater measure of safety than available in the prior art, the child 62 should nonetheless only ride the bicycle with proper safety gear such as, for example a bicycle helmet and pads and, likewise, the bicycle should be properly outfitted with reflectors, lights and the like. In any case, because the scope of the present invention is much broader than any particular embodiment, the foregoing detailed description should not be construed as a limitation of the scope of the present invention, which is limited only by the claims appended hereto.

What is claimed is:

1. An article for teaching a child to ride a bicycle, said article for teaching a child to ride a bicycle comprising:
a substantially rigid backboard, said substantially rigid backboard having a front face and a back face;
a handhold affixed to said front face of said substantially rigid backboard;
a cushion affixed to said back face of said substantially rigid backboard;
a harness affixed to said substantially rigid backboard, said harness being adapted to secure said article to the child such that said cushion is pressed firmly between said substantially rigid backboard and a generally central region of the child's upper back.

2. The article for teaching a child to ride a bicycle as recited in claim 1, wherein said handhold comprises a strap.

3. The article for teaching a child to ride a bicycle as recited in claim 2, wherein said strap is affixed to said front face of said substantially rigid backboard through an interposed anchor assembly.

4. The article for teaching a child to ride a bicycle as recited in claim 3, wherein said anchor assembly comprises a D-ring.

5. The article for teaching a child to ride a bicycle as recited in claim 2, wherein:
said strap is affixed to said front face of said substantially rigid backboard through an interposed first anchor assembly; and
said handhold further comprises a second anchor assembly.

6. The article for teaching a child to ride a bicycle as recited in claim 5, wherein:
said second anchor assembly comprises a D-ring; and
said strap is adapted to loop through said D-ring.

7. The article for teaching a child to ride a bicycle as recited in claim 6, wherein said strap comprises a first field of loop type material and a second field of hook type material, said first and second fields being cooperatively adapted to substantially secure said strap in place through said D-ring.

8. The article for teaching a child to ride a bicycle as recited in claim 5, wherein:
said first anchor assembly comprises a first D-ring and said second anchor assembly comprises a second D-ring; and
said strap is affixed at a first end thereof to said first D-ring and adapted to loop at a second end thereof through said second D-ring.

9. The article for teaching a child to ride a bicycle as recited in claim 6, wherein said strap comprises a first field of loop type material and a second field of hook type material, said first and second fields being cooperatively adapted to substantially secure said strap in place between said first D-ring and said second D-ring.

10. The article for teaching a child to ride a bicycle as recited in claim 1, wherein said harness comprises a plurality of straps.

11. The article for teaching a child to ride a bicycle as recited in claim 10, wherein said plurality of harness straps comprises a plurality of chest straps.

12. The article for teaching a child to ride a bicycle as recited in claim 10, wherein said plurality of harness straps further comprises a plurality of shoulder straps

13. The article for teaching a child to ride a bicycle as recited in claim 10, wherein said plurality of harness straps further comprises a plurality of abdominal straps.

14. The article for teaching a child to ride a bicycle as recited in claim 13, wherein said plurality of harness straps further comprises a plurality of shoulder straps.

15. The article for teaching a child to ride a bicycle as recited in claim 1, wherein:
said handhold comprises a hand strap; and
said harness comprises a plurality of harness straps.

16. The article for teaching a child to ride a bicycle as recited in claim 15, wherein said plurality of harness straps comprises a plurality of chest straps.

17. The article for teaching a child to ride a bicycle as recited in claim 16, wherein said plurality of harness straps further comprises a plurality of shoulder straps

18. The article for teaching a child to ride a bicycle as recited in claim 16, wherein said plurality of harness straps further comprises a plurality of abdominal straps.

19. The article for teaching a child to ride a bicycle as recited in claim 18, wherein said plurality of harness straps further comprises a plurality of shoulder straps.

20. The article for teaching a child to ride a bicycle as recited in claim 19, wherein:
said hand strap is affixed to said front face of said substantially rigid backboard through an interposed first anchor assembly and said handhold further comprises a second anchor assembly;
said first anchor assembly comprises a first D-ring and said second anchor assembly comprises a second D-ring; and
said hand strap is affixed at a first end thereof to said first D-ring and adapted to loop at a second end thereof through said second D-ring.
